(19) United States
(12) Patent Application Publication
(10) Pub. No.: US 2026/0111997 A1
(43) Pub. Date: Apr. 23, 2026

(54) METHOD OF CNN BASED INVERSION OF WAVE RADAR IMAGES AND USE THEREOF

(71) Applicant: Shanghai Jiao Tong University, Shanghai (CN)

(72) Inventors: Xiaoxian Guo, Shanghai (CN); Ziwei Ma, Shanghai (CN); Xin Li, Shanghai (CN); Wenyue Lu, Shanghai (CN); Xinliang Tian, Shanghai (CN)

(73) Assignee: Shanghai Jiao Tong University, Shanghai (CN)

(21) Appl. No.: 19/221,207

(22) Filed: May 28, 2025

Related U.S. Application Data
(63) Continuation-in-part of application No. PCT/CN2024/135103, filed on Nov. 28, 2024.

(30) Foreign Application Priority Data
Jun. 3, 2024 (CN) 202410711899.1

(51) Int. Cl. G06T 5/20

(52) U.S. Cl. CPC G06T 5/20; G06T 2207/10044; G06T 2207/20081; G06T 2207/20084

(57) ABSTRACT

A method of convolutional neural network (CNN) based inversion of wave radar images and use thereof pertain to the field of sea-state monitoring, in which a CNN autoencoder is employed. A training dataset produced by a simulation tool is input to the CNN autoencoder for supervised training, with X-band radar images of an inversion region being taken as input to the training dataset and with corresponding ocean surface wave height maps being taken as output from the training dataset, thereby deriving a model defining a mapping of them. The CNN autoencoder includes an encoder, fully connected layers and a decoder. The encoder includes five convolutional layers and five max-pooling layers, which are connected alternately. There are two symmetric fully connected layers, and the decoder includes five deconvolutional layers. A CNN-based deep learning algorithm is used to provide good reconstruction of the nonlinear components. The autoencoder technology is employed, which can directly reconstruct real-time ocean surface wave height maps from X-band radar wave images with minor errors, which provide more comprehensive sea-state information.

### RELATED APPLICATIONS

This application is a continuation-in-part (CIP) application claiming benefit of PCT/CN2024/135103 filed on Nov. 28, 2024, which claims priority to Chinese Patent Application No. 202410711899.1 filed on Jun. 3, 2024, the disclosures of which are incorporated herein in their entirety by reference.

### FIELD OF THE INVENTION

The present application relates to the field of sea-state monitoring, and particularly to a method of convolutional neural network (CNN) based inversion of wave radar images and use thereof.

### DESCRIPTION OF THE PRIOR ART

In order to allow for more efficient and safer exploitation of ocean resources, the need for clearly knowing sea-state changes in real time becomes more evident. Wave measurements provide one solution, and wave measurement results can be used in a variety of sectors including coastal protection, port management, navigational safety, coastal resource management and maritime rescue. Currently, wave measurements rely majorly on wave buoys and X-band radars. Wave buoys are not suitable for use in deep water environments and cannot be used aboard ships to obtain real-time measurements. In contrast, X-band radars are a highly promising sea-state sensing technique offering a wide range of advantages including small footprint, low cost, a small blind zone, real-time measurability, ability to continually monitor changes in a vast sea area and easy mobility. Images captured by an X-band radar can be processed to provide sea-state forecasts in real-time for navigating ships. There is an ongoing challenge to infer sea-state parameters in real time from images captured by an X-band radar.

Currently available methods for inferring sea-state parameters from X-band radar images are essentially those combining traditional mathematical and physical phenomena. A sequence of N consecutive X-band radar images is first selected, and an inversion region is then selected in the X-band radar images and subject to digitization, obtaining a temporal sequence I(x, y, z) of the X-band radar images. Subsequently, a three-dimensional discrete Fourier transform is applied to the temporal sequence I(x, y, z) of the X-band radar images to obtain a three-dimensional image spectrum, which is then filtered using a wave dispersion relationship and integrated over the positive frequency range, obtaining a two-dimensional image spectrum. A two-dimensional wave spectrum can be derived from the two-dimensional image spectrum by multiplying it by an empirical modulation transfer function. Other relevant sea-state parameters can be extracted from the two-dimensional wave spectrum.

However, X-band radars may be affected by shadowing modulation or other factors when scanning waves on an ocean surface. FIG. 2 explains how shadowing modulation occurs. As electromagnetic waves emitted from an X-band radar almost graze the surface of an ocean at an extremely small angle being formed with surface, but waves on the ocean surface may undulate, with some high ones of them possibly obstructing propagation of some electromagnetic waves, leading to absence of incident electromagnetic waves behind them. Consequently, there would be no or only weak echoes from the obstructed or shadowed areas. As one type of nonlinear imaging modulation, shadowing modulation is critical to marine radar imaging. As noted above, traditional inversion of sea-state parameters from X-band radar images involves multiplication by an empirical modulation transfer function for modulating nonlinear components. However, for some particular sea states, such empirical formulas are limited in application due to poor performance in reconstructing nonlinear wave components.

Therefore, it would be desirable in the art to develop a method of inversion based on X-band radar images.

### SUMMARY OF THE INVENTION

In view of the above described shortcomings of the prior art, the problem sought to be solved by the present application is how to develop a method of inversion based on X-band radar images, which enables better reconstruction of nonlinear wave components, such as those subject to shadowing modulation.

To this end, a method of convolutional neural network (CNN) based inversion of wave radar images is provided herein, which comprises:
producing, using a simulation tool, a training dataset which is X-band radar images of an inversion region and corresponding ocean surface wave height maps thereof;
determining input data for the training dataset and output data for the training dataset, with the X-band radar images of the inversion region being taken as input to the training dataset and with the corresponding ocean surface wave height maps as output from the training dataset; and
inputting the training dataset to a CNN autoencoder for supervised training, obtaining a model mapping the X-band radar images of the inversion region to the corresponding ocean surface wave height maps,
the CNN autoencoder comprising an encoder, fully connected layers and a decoder,
wherein the encoder comprises five convolutional layers and five max-pooling layers, which are connected alternately;
the fully connected layers include two symmetric layers; and
the decoder comprises five deconvolutional layers.

Additionally, the simulation tool is Matlab's radar toolbox.

Additionally, a nearest point of each X-band radar image of the inversion region to a center of an X-band radar is spaced at a distance greater than 500 meters from the center of the X-band radar.

Additionally, a nearest point of each X-band radar image of the inversion region to a center of an X-band radar is spaced at a distance greater than 600 meters from the center of the X-band radar.

Additionally, the X-band radar images of the inversion region have a resolution of 8 m.

Additionally, the X-band radar images of the inversion region are rectangles.

Additionally, the rectangles have a side length greater than 1200 m.

Additionally, the a nearest point of each rectangle to a center of an X-band radar may be spaced at a distance greater than 700 m from the center of the X-band radar.

Additionally, the rectangles have a length of 3000 m.

Additionally, the rectangles have a width of 1500 m.

Additionally, the method further comprises the step of resampling the X-band radar images of the inversion region and the corresponding ocean surface wave height maps into images of 512×256 pixels.

Additionally, the method further comprises the step of converting the X-band radar images of the inversion region and the corresponding ocean surface wave height maps into grayscale images.

Additionally, the method further comprises the step of normalizing grayscale values of the grayscale images from 0-255 to 0-1.

Additionally, the method further comprises the steps of: randomly adding Gaussian white noise to the X-band radar images of the inversion region, obtaining X-band radar images with interference from noise; and with the X-band radar images with interference from noise as input to the training dataset, deriving a model mapping the X-band radar images with interference from noise to the corresponding ocean surface wave height maps.

Additionally, the Gaussian white noise has a variance of 0 to 0.2.

Additionally, the method further comprises the steps of: randomly adding masks to the X-band radar images of the inversion region, obtaining X-band radar images with masking; and with the X-band radar images with masking as input to the training dataset, deriving a model mapping the X-band radar images with masking to the corresponding ocean surface wave height maps.

Also provided herein is use of the method of the CNN based inversion of the wave radar images in a ship-borne radar system.

Additionally, the ship-borne radar system comprises an X-band radar and a radar image processing computer, wherein the method of the inversion of the wave radar images is implemented by the radar image processing computer.

Additionally, the ship-borne radar system further comprises a radar image display.

Additionally, the X-band radar obtains corresponding real-time X-band radar images from real-time ocean surface scanning, wherein the real-time X-band radar images are displayed on the radar image display and transmitted to the radar image processing computer, and the radar image processing computer processes the real-time X-band radar images by inversion according to the method of the inversion of the wave radar images to obtain corresponding real-time ocean surface wave height maps of the real-time X-band radar images.

The present application offers the benefits as follows:

1) A CNN-based deep learning algorithm is used to provide good reconstruction of nonlinear components and find a relationship of input and output data without taking into account mathematical and physical principles involved therein. Such a nonlinear relationship can be obtained simply by training based on massive data, providing ease and convenience of operation.

2) The autoencoder can rapidly reconstruct, from X-band radar images input to the model, three-dimensional ocean surface wave height maps, instead of wave height, period and other two-dimensional sea-state parameters, with minor errors. Compared to wave height, period and other two-dimensional parameters, such three-dimensional ocean surface wave height maps can provide more comprehensive sea-state information.

3) Furthermore, CNNs can desirably extract and reconstruct general features of images even when data of one or more portions of them is missing, or when they contain significant interfering noise. Therefore, the problem of considerable errors in extraction of sea-state information from X-band radar images, which may occur in practice due to interference from noise or obstruction, is overcome.

4) The simulation toolbox can produce a large number of simulated X-band radar images and corresponding ocean surface wave height maps suitable for use as input and output data for training the CNN autoencoder, overcoming the problem of insufficient actual measurement data available for training.

For a full understanding of the objects, features and effects of the present application, the concept, structural details and resulting technical effects will be further described with reference to the accompanying drawings.

### BRIEF DESCRIPTION OF THE DRAWINGS

FIG. 1 is a flowchart of a method of inversion according to an embodiment the present application.

FIG. 2 schematically explains how shadowing modulation occurs.

FIG. 3 shows a schematic representation of hardware of a ship-borne radar system according to an embodiment of the present application.

FIG. 4 shows key components of a convolutional neural network (CNN) framework.

FIG. 5 shows a CNN autoencoder framework according to an embodiment of the present application.

FIG. 6 shows a rectangular inversion region selected in accordance with an embodiment of the present application.

FIG. 7 shows a corresponding ocean surface wave height map of an X-band radar image in an inversion region according to an embodiment of the present application.

FIG. 8 schematically illustrates a selected inversion region of an X-band radar image in a training dataset, which has been randomly added with Gaussian white noise with a variance of 0 to 0.2.

FIG. 9 schematically illustrates a selected inversion region of an X-band radar image in a training dataset, which has been randomly added with a mask.

### DETAILED DESCRIPTION OF THE PREFERRED EMBODIMENTS

A few preferred embodiments of the present application are described below with reference to the drawings accompanying this specification so that the techniques disclosed herein become more apparent and better understood. The present application may be embodied in many different forms, and its scope sought to be protected hereby is not limited only to the embodiments disclosed herein.

In the drawings, the size and thickness of each component are arbitrarily depicted, and the present application is not limited to the size or thickness of any component. For greater clarity of illustration, the thicknesses of some parts may be exaggerated somewhere in the drawings.

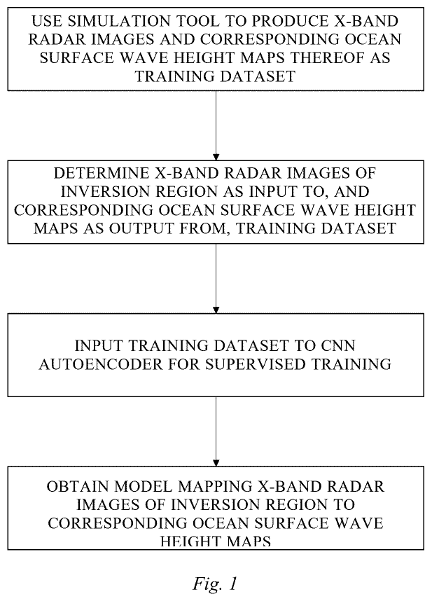

As shown in FIG. 1, in a method of convolutional neural network (CNN) based inversion of wave radar images disclosed herein, a simulation tool is used to produce X-band radar images and corresponding ocean surface wave height maps thereof, as a training dataset. Subsequently, X-band radar images of an inversion region are determined as input to the training dataset, and corresponding ocean surface wave height maps thereof as output from the training dataset. The CNN autoencoder is then employed, and the training dataset is input to a CNN autoencoder for supervised training, finally obtaining a model mapping the X-band radar images to the corresponding ocean surface wave height maps of the inversion region, which enables the method of inversion of such wave radar images.

Before training, an appropriate inversion region and corresponding ocean surface wave height maps thereof are selected in pre-existing X-band radar images to create a training dataset. The X-band radar images of the inversion region is taken as input to the training dataset, and the corresponding ocean surface wave height maps thereof as output from the training dataset.

A CNN autoencoder chosen herein has a framework including an encoder, fully connected layers and a decoder. The encoder includes five convolutional layers and five max-pooling layers, which are connected alternately. There are two symmetric fully connected layers. The decoder includes five deconvolutional layers.

In some embodiments, Matlab's radar toolbox is used as a simulation tool to produce a large number of pre-existing X-band radar images and corresponding ocean surface wave height maps thereof, addressing the lack of sufficient X-band radar image and corresponding ocean surface wave height maps in practice for training.

In some embodiments, an appropriate inversion region is selected with the following considerations.

Since side-lobe interference of an X-band radar may introduce near-field distortion to images that it has captured, the inversion region is avoided from being selected in the X-band radar images within a distance of 500 meters from the center of the X-band radar (e.g., as indicated by the circle of FIG. 6 that has a radius of 500 m), in order to reduce errors that may occur due to such image distortion. In order to additionally reduce the influence of radar image distortion, the inversion region may be selected in the X-band radar images at a distance of 600 m or more from the center of the X-band radar, for the reason that side-lobe echoes from a scanned area near the center of the X-band radar would undesirably be comparably strong to target echoes and thus affect the quality of the captured X-band radar images.

X-band radar images with a resolution of 8 m may be selected to enable the characterization of a wave with four points, which can reduce unwanted errors. Common waves have a period of 5 s to 14 s. Waves in deep-water areas are about 37.5 to 306 m long, and those in near-shore areas are about 35 to 102 m long. For a wavelength of 35 m or 37.5 m, X-band radar images with a resolution of 8 m can ensure four sample points for each wave.

The inversion region may be a rectangle. The rectangle has a side length at least greater than 1200 m, which can ensure that the rectangle encompasses at least 3.7 waves.

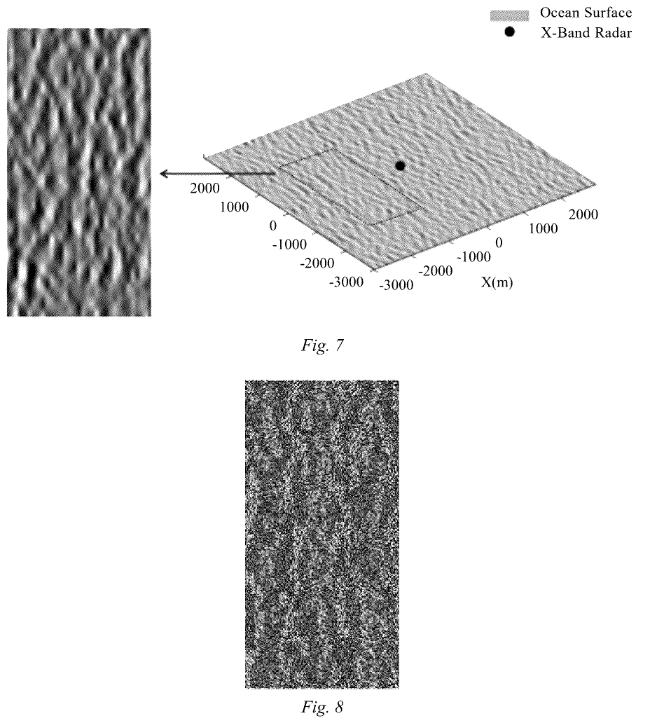

Preferably, a 3000-m long, 1500-m wide rectangle is selected as the X-band radar image in the inversion region at a distance greater than 700 m from the center of the X-band radar, as indicated by the rectangular box of FIG. 6, and the corresponding ocean surface wave height map of the X-band radar image in the inversion region is also selected in the ocean surface wave height maps, as shown in FIG. 7.

Preferably, all the selected X-band radar images and corresponding ocean surface wave height maps are resampled into images of 512×256 pixels, which are then converted into grayscale images. Grayscale values of the resulting images are then normalized from the range 0-255 to 0-1, obtaining 512×256-pixel X-band radar images and corresponding ocean surface wave height with grayscale values range of 0-1. Normalizing the data to the same size and range can improve the performance and accuracy of the machine learning algorithm used.

Afterwards, the above selected inversion region, as the training dataset, is input to a CNN autoencoder for training. Specifically, the X-band radar images of the inversion region, as input, and the corresponding ocean surface wave height maps, as output, are subjected to supervised training for finding a mapping between them, which enables the method of inversion of such wave radar images.

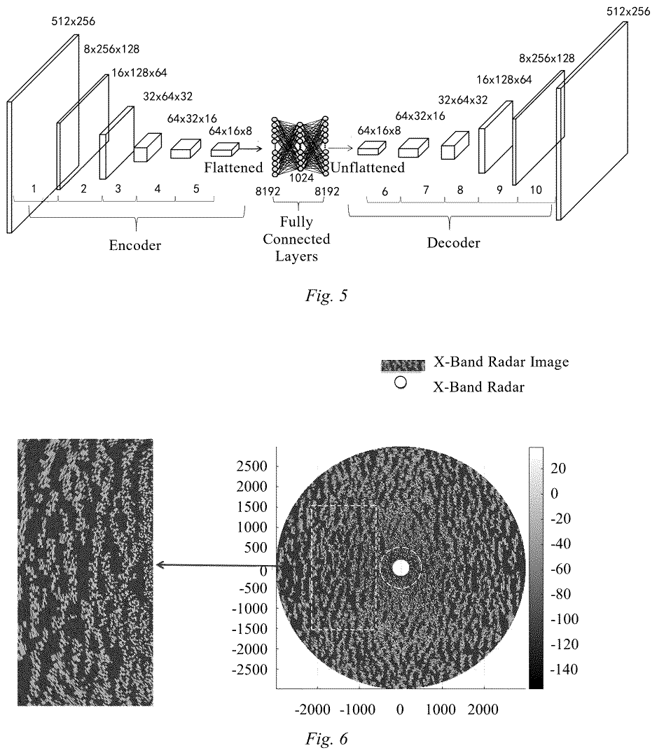

In some embodiments, as shown in FIG. 5, a framework of the CNN autoencoder includes an encoder, fully connected layers and a decoder. The encoder includes five convolutional layers and five max-pooling layers, which are connected alternately. That is, each of the convolutional layers is immediately succeeded by one max-pooling layer, which respectively corresponds to (1, 2, 3, 4, 5) in FIG. 5. There are two symmetric fully connected layers. The decoder includes five deconvolutional layers, which respectively corresponds to (6, 7, 8, 9, 10) in FIG. 5.

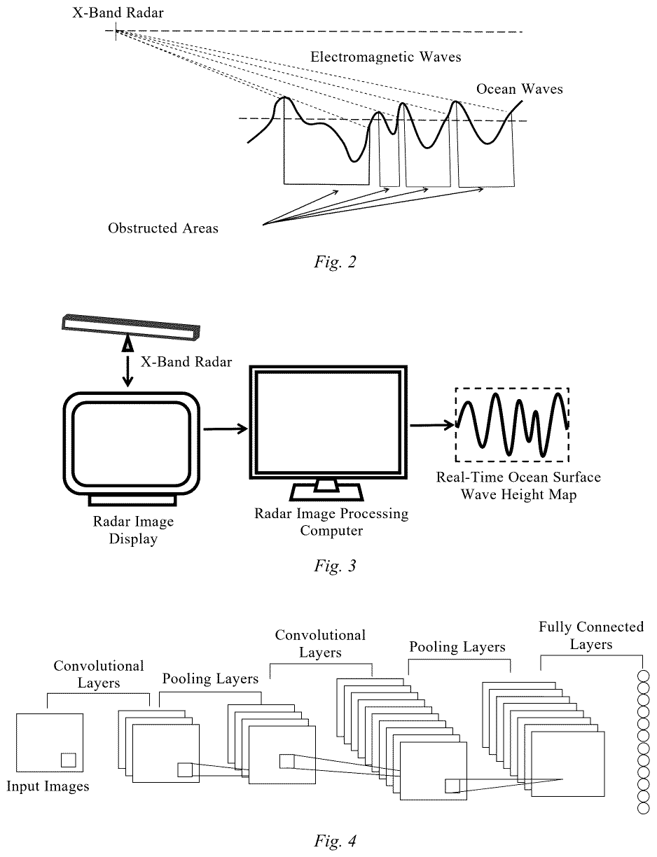

CNNs are a type of multi-layer artificial neural networks designed to process two-dimensional input data. As shown in FIG. 4, key parts of a CNN essentially include convolutional layers, pooling layers and final fully connected layers. A CNN's processing begins with convolution and pooling processes. Output of the convolution process is taken as input to the pooling layers, and the results from the pooling layers are again input to the convolutional layers for the next convolution process. The fully connected layers serve for final connection. Because of fewer network connections and weight parameters, the use of a CNN model can effectively reduce learning complexity and enables easier training.

An autoencoder is an artificial neural network consisting of two parts: an encoder and a decoder. Given an input space X∈M and a space of latent-layer features h∈F, an autoencoder finds a mapping f, g of them, which minimizes a reconstruction error of the input features.

$$f : M \to F$$

$$g : F \to M$$

$$f , g = arg {min}_{f , g} {‖ X - g [ f ( X ) ] ‖}^{2}$$

where X represents input data; M, a space of the input data; h, the latent-layer features; F, the space of the latent-layer features; f, a function mapping of the encoder; g, a function mapping of the decoder; and g[f(X)], reconstructed data. As a result of processing of the autoencoder, the latent-layer features h output from the encoder can be considered as characterizing the input data X. An autoencoder takes input information as a learning target and learns how to characterize the input information using a training network, which extracts the most essential part of the input images and derive a low-dimensional representation of the high-dimensional data. Autoencoder have surpassed traditional engineering techniques in many applications in terms of accuracy and performance and are useful in anomaly detection, text generation, image generation, image denoising, etc.

Combining CNNs' advantages in image information recognition and extraction and autoencoders' advantages in image generation and reconstruction, an appropriate CNN-autoencoder framework is designed herein to enable a method of inversion of wave radar images, which can reconstruct and reproduce practical ocean surface wave height maps from X-band radar images with reduced errors.

In some embodiments, as shown in FIG. 3, the method of the inversion of the wave radar images is embodied in hardware of a ship-borne radar system essentially including an X-band radar on board the ship, a radar image display and a radar image processing computer. The method of the inversion of the wave radar images is implemented on the radar image processing computer. The X-band radar performs real-time ocean surface scanning, and the captured real-time X-band radar images are displayed on the radar image display and transmitted to the radar image processing computer, wherein they are processed for inversion according to the method of the inversion of the wave radar images in the radar image processing computer. Finally, corresponding real-time ocean surface wave height maps of the X-band radar images are obtained and output. In this way, X-band radar images obtained from scanning of the X-band radar can be accurately converted in real time into practical three-dimensional ocean surface wave height maps, which can provide real-time sea-state feedback for navigating the ship. Such reference information can help the crew know how well the ship is being navigated and determine a correct waterway. Additionally, wave height profiles at particular locations in an ocean surface area of interest can be directly obtained from the real-time ocean surface wave height maps. Radar images in a certain temporal sequence can be sequentially converted into ocean surface wave height maps, from which temporal sequences of wave height maps can be directly obtained for particular locations in an ocean surface area of interest.

In some embodiments, for the method of inversion of X-band radar images with interference from noise, Gaussian white noise with a variance of 0 to 0.2 is randomly added to the X-band radar images of the training dataset in the inversion region, as shown in FIG. 8. X-band radar images with interference from noise are obtained. Supervised training is then carried out on the training dataset instead with the X-band radar images with interference from the noise as input and still with the corresponding ocean surface wave height maps as output, deriving a model mapping the X-band radar images with interference from the noise to the corresponding ocean surface wave height maps. This enables the method of inversion of X-band radar images with interference from noise, making the method immune from interference from noise in X-band radar images.

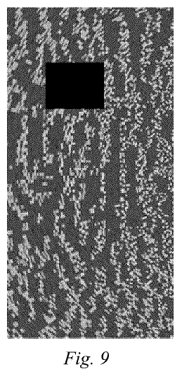

In some embodiments, for the method of inversion of X-band radar images with masking, masks are randomly added to the X-band radar images of the training dataset in the inversion region, as shown in FIG. 9. Supervised training is then carried out on the training dataset instead with the randomly masked X-band radar images as input and still with the corresponding ocean surface wave height maps as output, deriving a model mapping the masked X-band radar images to the corresponding ocean surface wave height maps. This enables the method of inversion to handle X-band radar images with masking.

Therefore, in addition to obtaining practical three-dimensional ocean surface wave height maps of X-band radar images based on CNN-based inversion, the method proposed herein can also be used to handle X-band radar images with significant interference from noise and X-band radar images with masking resulting from missing signals from one or more obstructed ocean surface areas. In consideration of effectiveness of CNNs to extract general features from images, a CNN-autoencoder model is employed to perform supervised learning with X-band radar images with noise and/or masking as input and with practical ocean surface wave height maps thereof as output. The trained model can be used to obtain ocean surface wave height maps of X-band radar images with interference from noise and/or masking by inversion.

Although a few preferred specific embodiments of the present application have been described in detail above, it will be understood that those of ordinary skill in the art can make various modifications and changes thereto based on the concept of the present application without exerting any creative effort. Accordingly, all variant embodiments that can be obtained by those skilled in the art through logical analysis, inference or limited experimentation in accordance with the concept of the present invention on the basis of the prior art are intended to fall within the scope as defined by the appended claims.

1. A method of convolutional neural network (CNN) based inversion of wave radar images, wherein the method comprises:
producing, using a simulation tool, a training dataset which is X-band radar images of an inversion region and corresponding ocean surface wave height maps thereof;
determining input data for the training dataset and output data for the training dataset, with the X-band radar images of the inversion region being taken as input to the training dataset and with the corresponding ocean surface wave height maps as output from the training dataset; and
inputting the training dataset to a CNN autoencoder for supervised training, obtaining a model mapping the X-band radar images of the inversion region to the corresponding ocean surface wave height maps,
the CNN autoencoder comprising an encoder, fully connected layers and a decoder,
wherein the encoder comprises five convolutional layers and five max-pooling layers, which are connected alternately;
the fully connected layers include two symmetric layers; and
the decoder comprises five deconvolutional layers.

2. The method of the CNN based inversion of the wave radar images of claim 1, wherein the simulation tool is Matlab's radar toolbox.

3. The method of the CNN based inversion of the wave radar images of claim 1, wherein a nearest point of each X-band radar image of the inversion region to a center of an X-band radar is spaced at a distance greater than 500 meters from the center of the X-band radar.

4. The method of the CNN based inversion of the wave radar images of claim 1, wherein a nearest point of each X-band radar image of the inversion region to a center of an X-band radar is spaced at a distance greater than 600 meters from the center of the X-band radar.

5. The method of the CNN based inversion of the wave radar images of claim 1, wherein the X-band radar images of the inversion region have a resolution of 8 m.

6. The method of the CNN based inversion of the wave radar images of claim 1, wherein the X-band radar images of the inversion region are rectangles.

7. The method of the CNN based inversion of the wave radar images of claim 6, wherein the rectangles have a side length greater than 1200 m.

8. The method of the CNN based inversion of the wave radar images of claim 6, wherein a nearest point of each rectangle to a center of an X-band radar is spaced at a distance greater than 700 m from the center of the X-band radar.

9. The method of the CNN based inversion of the wave radar images of claim 8, wherein the rectangles have a length of 3000 m.

10. The method of the CNN based inversion of the wave radar images of claim 8, wherein the rectangles have a width of 1500 m.

11. The method of the CNN based inversion of the wave radar images of claim 1, further comprising the step of resampling the X-band radar images of the inversion region and the corresponding ocean surface wave height maps into images of 512×256 pixels.

12. The method of the CNN based inversion of the wave radar images of claim 1, further comprising the step of converting the X-band radar images of the inversion region and the corresponding ocean surface wave height maps into grayscale images.

13. The method of the CNN based inversion of the wave radar images of claim 12, further comprising the step of normalizing grayscale values of the grayscale images from 0-255 to 0-1.

14. The method of the CNN based inversion of the wave radar images of claim 1, further comprising the steps of: randomly adding Gaussian white noise to the X-band radar images of the inversion region, obtaining X-band radar images with interference from noise; and with the X-band radar images with interference from noise as input to the training dataset, deriving a model mapping the X-band radar images with interference from noise to the corresponding ocean surface wave height maps.

15. The method of the CNN based inversion of the wave radar images of claim 14, wherein the Gaussian white noise has a variance of 0 to 0.2.

16. The method of the CNN based inversion of the wave radar images of claim 1, further comprising the steps of: randomly adding masks to the X-band radar images of the inversion region, obtaining X-band radar images with masking; and with the X-band radar images with masking as input to the training dataset, deriving a model mapping the X-band radar images with masking to the corresponding ocean surface wave height maps.

17. Use of the method of the CNN based inversion of the wave radar images of claim 1 in a ship-borne radar system.

18. The use of the method of the CNN based inversion of the wave radar images of claim 17, wherein the ship-borne radar system comprises an X-band radar and a radar image processing computer, wherein the method of the inversion of the wave radar images is implemented by the radar image processing computer.

19. The use of the method of the CNN based inversion of the wave radar images of claim 17, wherein the ship-borne radar system further comprises a radar image display.

20. The use of the method of the CNN based inversion of the wave radar images of claim 19, wherein the X-band radar obtains corresponding real-time X-band radar images from real-time ocean surface scanning; the real-time X-band radar images are displayed on the radar image display and transmitted to the radar image processing computer; the radar image processing computer processes the real-time X-band radar images by inversion according to the method of the inversion of the wave radar images to obtain corresponding real-time ocean surface wave height maps of the real-time X-band radar images.
